(19) United States
(12) Patent Application Publication
(10) Pub. No.: US 2017/0124554 A1
(43) Pub. Date: May 4, 2017

(54) REMOTE ELECTRONIC ACTIVATION SYSTEM

(71) Applicant: Pursuant Health, Inc., Atlanta, GA (US)

(72) Inventor: Ryan Sloan, Atlanta, GA (US)

(21) Appl. No.: 15/338,693

(22) Filed: Oct. 31, 2016

Related U.S. Application Data
(60) Provisional application No. 62/248,924, filed on Oct. 30, 2015.

(51) Int. Cl. G06Q 20/34; G06K 7/10; H04L 29/06; G06F 19/00

(52) U.S. Cl. CPC G06Q 20/354; G06F 19/3431; G06K 7/10554; G06Q 20/351; G06Q 20/349; H04L 63/08

(57) ABSTRACT

A server system may include a processing device and a memory device for causing the processing device to: (i) determine an assessment for performance by the member based on the incentive program associated with stored identifying information that corresponds to the identifying information received from a medical screening apparatus; (ii) transmit a first control signal to the medical screening apparatus for prompting the member to initiate the assessment; (iii) receive assessment information from the medical screening apparatus; (iv) determine an incentive value associated with completion of the assessment; (v) transmit a second control signal to a payment-processing server to cause the payment-processing server to apply the incentive value to a payment card associated with the member; and (vi) transmit a third control signal to the medical screening apparatus to cause the medical screening apparatus display a message that the incentive value is associated with the payment card.

### CROSS-REFERENCE TO RELATED APPLICATIONS

This claims priority to U.S. Provisional Application Ser. No. 62/248,924, filed Oct. 30, 2015 and titled “System and Method for Remote Activation of Voucher/Card by an Incentive Program Member,” the contents of each of which are incorporated herein by reference.

### TECHNICAL FIELD

The present disclosure relates to multicomputer data transferring, and more particularly, though not necessarily exclusively, to electronic activation of payment cards from a remote server.

### BACKGROUND

Healthcare in the United States has undergone substantial changes over the last several years, in particular with the adoption of the Affordable Healthcare Act. The Affordable Healthcare Act that was designed with a stated goal of trying to provide affordable access to healthcare plans to all segments of society. However, a fundamental issue facing the United States healthcare systems is a rise in healthcare expenses in response to a progressively unhealthy population. For example, chronic medical conditions have been estimated as accounting for as much as approximately 86% of total healthcare expenses. Many of such chronic conditions are caused by factors such as obesity, smoking and other unhealthy habits or behaviors that often are avoidable or can be prevented by practicing good health habits.

To promote good health habits and practices among insured members, many health insurance sponsors or providers offer health and wellness programs that focus on behavioral intervention. Such programs, particularly those targeting unhealthy habits and/or negative behaviors, may provide incentives for participation or completion of such wellness programs to motivate or reward members to perform certain actions that may result in changed behavioral patterns. Offering incentives or rewards for meeting goals or program participation levels generally has been a proven method for creating behavior change. However, when there is a significant gap or delay between performance of a desired behavior change or action or completion of program requirements and the participant getting their reward, it has been found that people are less likely to participate in or continue the program. Programs with more immediate rewards and liquid incentives (such as cash or cash-equivalent cards) provide more instantaneous gratification and have been found to create more positive reinforcement that drive higher participation levels.

A further issue that has been observed with some health and wellness programs is the inconvenience or difficulty for program participants to meet requirements of the program in order to receive their incentive. For example, programs that require participants to complete extensive health risk assessments and collection of various biometric data, or require their attendance at a health screening events, doctor visits and/or sign-off, or trips to a lab, such additional steps and inconvenience can tend to drive low participation in the program.

It therefore can be seen that need exists for a system and method for promotion of health and wellness programs, including the offering of assessments or screenings at conveniently placed locations, such as health and wellness kiosks, which allow for real-time incentives to encourage higher participation rates and more sustainable user engagement in health and wellness programs.

### SUMMARY

Briefly described, the present disclosure generally relates to systems and processes for electronically activating a payment card in response to performing a healthcare screening assessment via a medical screening apparatus.

In one aspect of the present disclosure, a system may include a processing device and a memory device including instructions for causing the processing device to, in response to receiving, from a medical screening apparatus communicatively coupled to the server system via a network, identifying information corresponding to a member of an incentive program from a medical screening apparatus communicatively coupled to the server system via a network, determine an assessment for performance by the member based on the incentive program associated with stored identifying information corresponding to the identifying information and stored in a database accessible to the processing device. The instructions may also cause the processing device to transmit a first control signal to the medical screening apparatus to cause the medical screening apparatus to prompt the member to initiate the assessment. The instructions may also cause the processing device to receive assessment information from the medical screening apparatus, the assessment information corresponding to information generated by the medical screening apparatus in response to the member performing the assessment. The instructions may also cause the processing device to determine an incentive value associated with completion of the assessment. The instructions may also cause the processing device to transmit a second control signal to a payment-processing server communicatively coupled to the server system via the network to cause the payment-processing server to apply the incentive value to a payment card associated with the member. The instructions may also cause the processing device to transmit a third control signal to the medical screening apparatus to cause the medical screening apparatus to generate one or more user interfaces that are displayable on a display screen of the medical screening apparatus and include a message informing the member that the incentive value is associated with the payment card.

In another aspect of the present disclosure, a computer-implemented method may include determining an assessment for performance by a member of an incentive program based on the incentive program associated with identifying information received from a medical screening apparatus communicatively coupled to the m in a database accessible to the processing device. The method may also include transmitting a first control signal to the medical screening apparatus to cause the medical screening apparatus to prompt the member to initiate the assessment. The method may also include receiving assessment information from the medical screening apparatus, the assessment information corresponding to information generated by the medical screening apparatus in response to the member performing the assessment. The method may also include determining an incentive value associated with completion of the assessment. The method may also include transmitting a second control signal to a payment-processing server communicatively coupled to the server system via the network to cause the payment-processing server to apply the incentive value to a payment card associated with the member. The method may also include transmitting a third control signal to the medical screening apparatus to cause the medical screening apparatus to generate one or more user interfaces that are displayable on a display screen of the medical screening apparatus and include a message informing the member that the incentive value is associated with the payment card.

In a further aspect of the present disclosure, a computer-implemented method may include receiving by a medical screening apparatus, identifying information corresponding to a member of a healthcare incentive program. The method may also include authenticating the member to perform a healthcare assessment using the medical screening apparatus. The method may also include administering the healthcare assessment to the member in response to a first control signal received from a remote server communicatively coupled to the medical screening apparatus via a network. The method may also include receiving assessment information corresponding to the healthcare assessment. The method may also include transmitting the assessment information to the remote server communicatively coupled to the medical screening apparatus. The method may also include receiving a second control signal from the remote server. The method may also include generating, in response to receiving the second control signal, one or more user interfaces indicating to the member that an incentive value corresponding to successful completion of the healthcare assessment is applied to a payment card associated with to the member and the healthcare incentive program.

Various objects, features and advantages of the present invention can be understood upon a view of the following Detailed Description, when taken in conjunction with the accompanying

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 is a block schematic diagram of an electronic activation system according to some aspects of the present disclosure.

FIG. 2 is a perspective view of a medical health screening apparatus according to some aspects of the present disclosure.

FIG. 3 is a perspective view of a payment card according to some aspects of the present disclosure.

FIG. 4 is a block diagram of the medical health screening apparatus and the control server of FIG. 1 according to some aspects of the present disclosure.

FIG. 5 is a flow chart of a process for administering a health screening assessment according to some aspects of the present disclosure.

FIG. 6 is a flow chart of a process for electronically activating a payment card according to some aspects of the present disclosure.

FIG. 7 is a list of example medical information provided to an incentive program sponsor according to some aspects of the present disclosure.

### DETAILED DESCRIPTION

Examples are described herein in the context of a real-time electronic activation system for a healthcare incentive program. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

Illustrative Example of a Remote Electronic Activation System

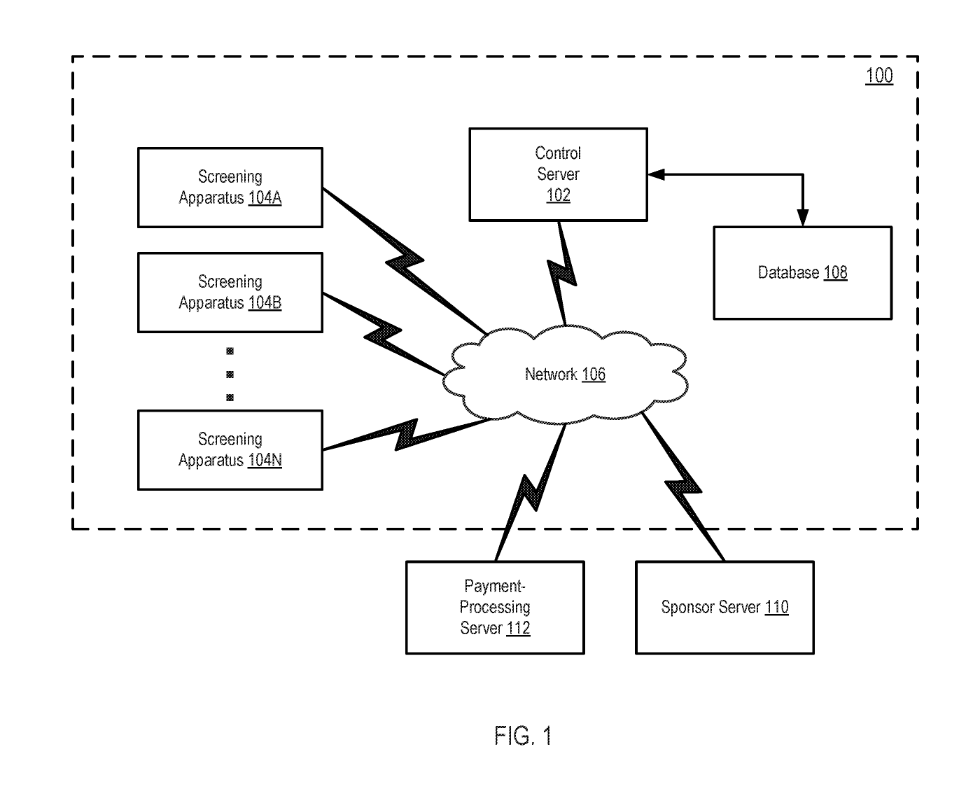

One example system is shown in FIG. 1. FIG. 1 shows an electronic activation system 100 including a control server 102 and multiple screening apparatuses 104A-104N. The control server 102 is communicatively coupled to each of the screening apparatuses 104A-104N via a network 106. The control server 102 may include one or more processing devices configured to execute instructions (e.g., programming code) for transmitting control signals to the screening apparatus 104A-104N to cause the screening apparatuses 104A-104N to prompt members of incentive program to perform assessments corresponding to the incentive program and reward the members for successful completion of the assessments.

In this example, each member of an incentive program is issued a payment card for the incentive program. The payment card includes a barcode having identifying information corresponding to a member and the relevant incentive program. A screening apparatus (e.g., screening apparatus 104A) comprises a health care kiosk including an optical scanner configured to extract the identifying information from the barcode and transmit the identifying information to the control server 102. The control server 102 may authenticate the member. For example, the control server may authenticate the member based on the identifying information extracted from the barcode and stored authentication information that is stored in a database 108. The control server 102 also determines an available health assessment (e.g., testing the member's blood pressure) that may be administered by the screening apparatus 104A. The available health assessment is determined based on the identifying information, the incentive program, and any previously performed assessments. For example, the control server 102 may identify health information corresponding to the member that is associated with the identifying information in the database 108. The health information may be received, in part, from a sponsor server 110 hosted by a sponsor of the incentive plan (e.g., an insurance company). A health assessment may be available where it corresponds to an incentive program in which the member is enrolled and where the member has not yet performed the assessment.

Subsequent to authenticating the member and the mem be r's acceptance of any terms for participation in the program, such as HIPAA consent agreements, etc., the participant will be provided with a welcome or initiation screen, which generally can include a series of instructions or rules for their completion of the health assessment. Thereafter, the member or participant will complete the required health assessment. For example, the screening apparatus 104A may include a blood pressure measurement device to allow the member to perform a health assessment corresponding to a blood pressure test.

Upon receiving the member's blood pressure measurements, the screening apparatus 104A may transmit the measurements to the control server 102 as assessment information. In some aspects, the control server 102 determines an appropriate incentive value for completing the assessment. For example, the healthcare kiosk may determine that according to the incentive program, the member is entitled to an incentive of $10. The control server 102 transmits an activation control signal to a payment-processing server 112 communicatively coupled to the control server 102 via the network 106. The payment-processing server 112 may be hosted by a bank or other payment-processing entity responsible for loading incentives onto the payment cards for the incentive program. The activation control signal transmitted to the payment-processing server 112 corresponds to one of a request to load the incentive value (e.g., $10) onto the payment card or to activate the payment card. The control server 102 also transmits an interface control signal to the healthcare kiosk. The interface control signal may cause the healthcare kiosk to display messages on a display screen of the healthcare kiosk informing the member that assessment was successfully completed and the associated incentive is included on the payment card. In this manner, incentive is issued to the member upon completion of the health assessment in real-time (e.g., prior to the completion of the member's visit to the healthcare kiosk). The member may subsequently use the payment card similar to a stored value card, debit card, or credit card to perform a transaction, such as a purchase of a good using the incentive.

In a conventional incentive program system, there is a significant delay between completion of a health assessment and the activation of a payment card for use by a member. For example, the system may transmit assessment information to a payment-processing system indicating that an assessment has been completed. But, the payment-processing system may require multiple verifications from multiple sources (e.g., an insurance provider, a primary care provider, etc.) before any incentive is distributed by the payment-processing system to active the payment card. In additional and alternative examples, the system may not have access to the member's information to determine an appropriate incentive value for activing either the payment card or the appropriate assessment to require members to complete for a specified incentive value. The ability of the control server 102 to access member's healthcare information and transmit electronic signals between the medical screening apparatuses 104A-104N and the payment-processing server 112 as described herein to control the electronic activation of the payment card allows for real-time activation of the payment card without the delays experienced in conventional systems.

This illustrative example is given to introduce the reader to the general subject matter discussed herein and the disclosure is not limited to this example. The following sections describe various additional non-limiting examples and examples of systems and methods for electronic activation systems.

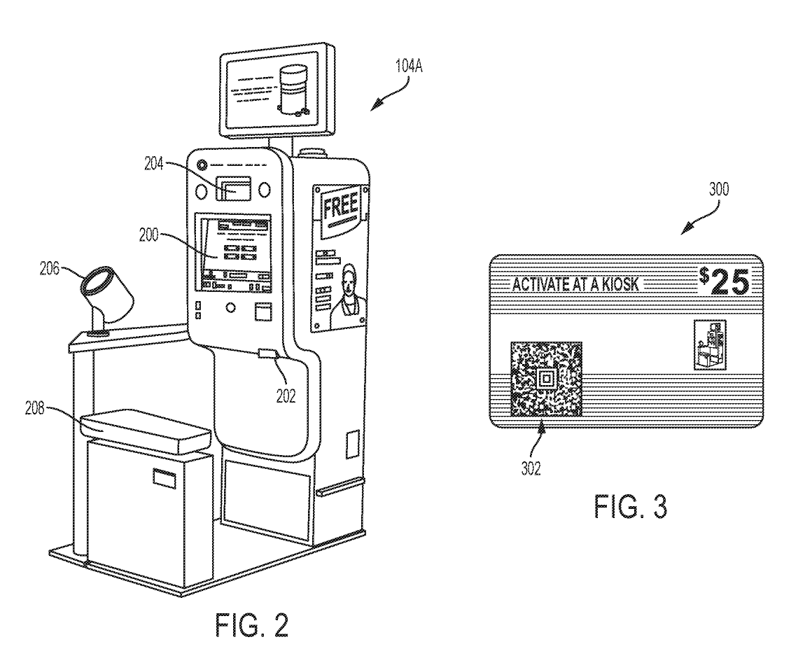

Referring now to FIG. 2, FIG. 2 shows one example of the medical screening apparatuses 104A described in FIG. 1. The medical screening apparatus 104A includes a healthcare kiosk. The kiosk may be positioned at a location that is separate from the control server 102 of FIG. 1 and that provides easy accessibility to members of a healthcare incentive program. For example, the kiosk may be positioned in a retail location, such as a pharmacy or grocery store. The kiosk includes a display unit 200, an optical scanner 202, a vision-screening system 204, a blood pressure measurement device 206, and a seat 208 including weight sensors for measuring a member seated in the seat 208. Although a specific set of measurement tools are shown as included in the medical screening apparatus 104A of FIG. 2, a measurement screening apparatus according to aspects of the present disclosure may include a combination of measurement tools for performing healthcare assessments without departing from the scope of the present disclosure. For example, a medical screening apparatus 104A may not include all of the measurement tools shown in FIG. 2 or may include additional measurement tools. In another example, the medical screening apparatus 104A may not include any measurement tools and allow a member to input assessment information obtained using measurement tools separate from the medical screening apparatus 104A.

The display unit 200 includes a display screen configured to display user interfaces generated by the kiosk. The display unit 200 may be coupled to a processing device of the kiosk and may include any CRT, LCD, OLED, or other device for displaying the user interfaces generated by the kiosk. In some aspects, the display unit 200 may include a touchscreen, keyboard and mouse, or other data entry device that allows the user to select selection options displayed on the user interfaces and input information via input options displayed on the user interfaces. In additional and alternative aspects, the display unit 200 may also include audio components to emit audible signals corresponding to the user interfaces.

The optical scanner 202 may include one or more light sources configured to emit light beams to scan a barcode and digitally convert the barcode into data corresponding to identifying information included in the barcode. For example, the member may place a payment card including the barcode in an optical path of the optical scanner 202 and the optical scanner 202 may extract the identifying information from the barcode.

FIG. 3 shows an example of a payment card 300 that corresponds to a member of the incentive program. In some aspects, the payment card 300 may include a plastic material and resemble a credit card, debit card, or other type of payment card that is typically found in a person's wallet or purse. In other aspects, the payment card 300 may include a paper material or other material. For example, the payment card 300 may resemble a voucher or gift certificate. The payment card 300 includes a barcode 302. Examples of the barcode 302 may include a traditional barcode, a QR code, or other code readable by an optical scanner (e.g., the optical scanner 202 of FIG. 1). The barcode 302 includes identifying information corresponding to the member to which the payment card 300 was issued. In some examples, an optical scanner may scan the barcode 302 and extract the identifying information from the barcode 302.

Although the payment card 300 is described in FIG. 3 as physical card, the payment card 300 may also represent a virtual payment card. For example, the payment card 300 may include a display of a payment card or the barcode 302 on a member's mobile computing device (e.g., a smartphone, a smartwatch, tablet computer, etc.). In another example, the payment card 300 may include an alphanumeric code that may be entered by the member via the display unit 200 of FIG. 2. The code may include or otherwise correspond to the identifying information.

Returning to FIG. 2, in some aspects, the vision-screening system 204 includes vision-screening equipment such as an autorefractor, autolensometer, autophoropter, or other device for measuring properties of a member's eyes (e.g., refraction). In additional and alternative aspects, the vision-screening system includes a display screen including charts for performing vision tests (e.g., a Snellen test consisting of several lines of letters) and requires the member to input via the display unit 200 or other means responses to the vision test.

The blood pressure measurement device 206 includes a blood pressure sleeve or cuff that may include inflatable components to surround a member's arm to measure the member's blood pressure. The seat 208 includes a seat and weight sensors to measure a member's weight when the member is positioned in the seat 208. In some aspects, the weight sensors are calibrated to account for the seated position of the member. For example, the weight sensors may adjust the weight measurement by a predetermined percentage or a value determined based on known or inputted information corresponding to the member to account for the member's feet, portions of the member's legs, and other body parts that may not be measurable by the seat 208. In some aspect, the seat 208 may be movable or removable to allow for wheelchair accessibility or adjustments for member comfort.

Although the screening apparatus 104A is depicted as a healthcare kiosk in FIG. 2, one or more of the screening apparatuses 104A-104N may further include other types of computing devices, including, for example, a mobile computing device (e.g., a mobile phone). For example, a mobile computing device may include a mobile application that executes the interface engine 408 to display a series of user interfaces. In this manner, the measurement devices 404 may correspond to accessories of the mobile computing device that are communicatively coupled to the mobile computing devices to transmit measurement parameters to the mobile computing device (e.g., an electronic scale, a blood pressure cuff, etc.). In other aspects, the mobile computing device may not include measurement devices 404, but instead rely on user input of assessment information.

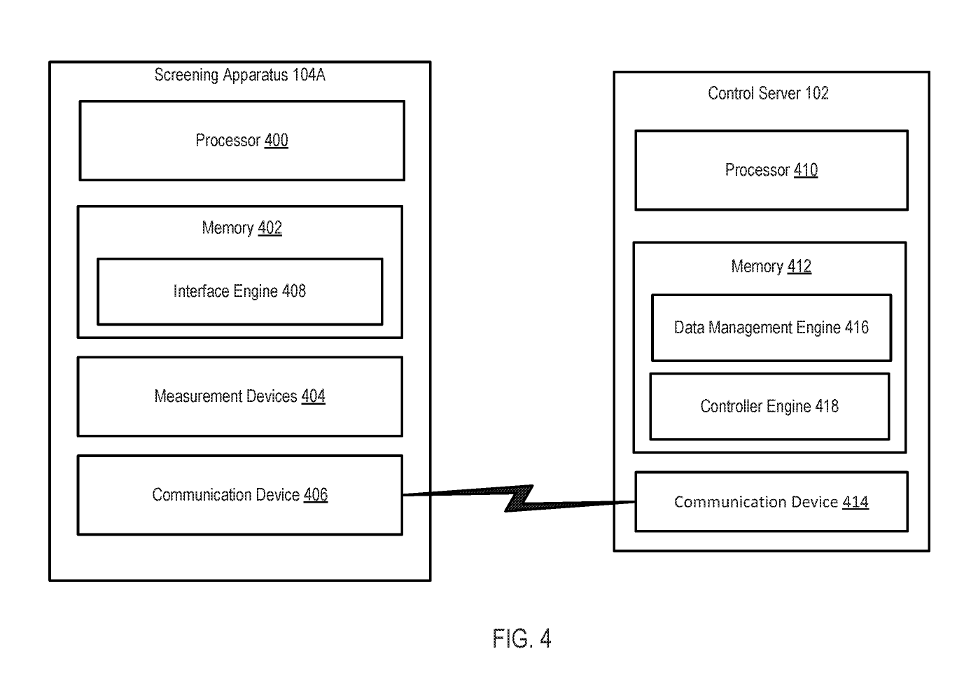

FIG. 4 is a block diagram showing the screening apparatus 104A and the control server 102 of FIG. 1 according to an aspect of the present disclosure. The screening apparatus 104A includes a processor 400, a memory 402, measurement devices 404, and a communication device 406. In some aspects, these devices may be disposed in a housing of the screening apparatus 104A and be communicatively coupled by a bus. The processor 400 may execute instructions

The processor 400 may execute instructions stored in the memory 402 to perform operations of the screening apparatus 104A. The processor 400 may include a single processing device or multiple processing devices. Non-limiting examples of the processor 400 include a field-programmable gate array, an application-specific integrated circuit (“ASIC”), and a microprocessor. The memory 402 includes a storage device that retains information when powered off. Non-limiting examples of the memory 402 include electrically erasable and programmable read-only memory, a flash memory, or any other type of non-volatile memory.

In some examples, at least a portion of the memory 402 may include a computer-readable medium from which the processor 400 can access and execute instructions of the memory 402. A computer-readable medium may include electrical, optical, magnetic, or other storage devices capable of providing the processor 400 with computer-readable instructions or other program code. Non-limiting examples of a computer-readable medium include magnetic disks, memory chips, read-only memory, random-access memory, an ASIC, a configured processor, optical storage, or any other medium from which the processor 400 may read instructions. The instructions may include processor-specific instructions generated by a compiler or an interpreter from code written in any suitable computer-programming language, including, for example, C, C++, C#, COBOL, Java, etc.

The instructions include one or more applications or other means for instructing the processor 400 to perform the functions of the screening apparatus 104A. For example, the instructions may instruct the processor 400 to actuate one or more of the measurement devices 404 to perform healthcare assessments with the member. In some aspects, the instructions include interface engine 408, including one or more algorithms executable by the processor 400 to cause the processor 400 to generate user interfaces to display messages to the member or to guide the member through a healthcare assessment.

The measurement devices 404 include one or more devices or tools to perform assessments. For example, the measurement devices 404 include at least the vision-screening system 204, the blood pressure measurement device 206, and the seat 208 of FIG. 2. The communication device 406 may include a network card or other means for communicatively coupling the screening apparatus 104A to the control server 102.

The control server 102 similarly includes a processor 410, a memory 412, and a communication device 414. The processor 410 may execute instructions stored in the memory 422 to perform operations of the control server 102. The processor 410, the memory 412, and the communication device 414 may be similar in structure to the processor 400, the memory 402, and the communication device 406 of the screening apparatus 104A as described herein. In some aspects, the instructions stored in the memory 412 of the control server 102 include data management engine 416 and controller engine 418, including one or more algorithms executable by the processor 410. For example, the data management engine 416 may cause the processor 410 to retrieve and identify information stored in a database communicatively coupled to the control server (e.g., database 108 of FIG. 1) and to make determinations based on the data. The controller engine 418 may cause the processor 410 to generate control signals including instructions or other data that may be transmitted to the screening apparatus 104A and the payment-processing server 112 via the communication device 414 to instruct the screening apparatus 104A and the payment-processing server 112 to perform various tasks as described herein.

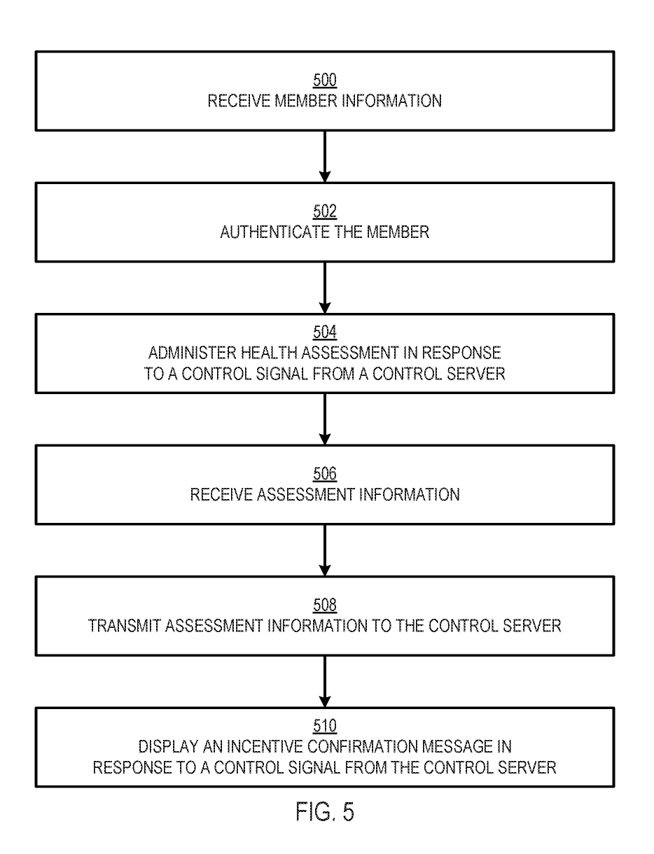

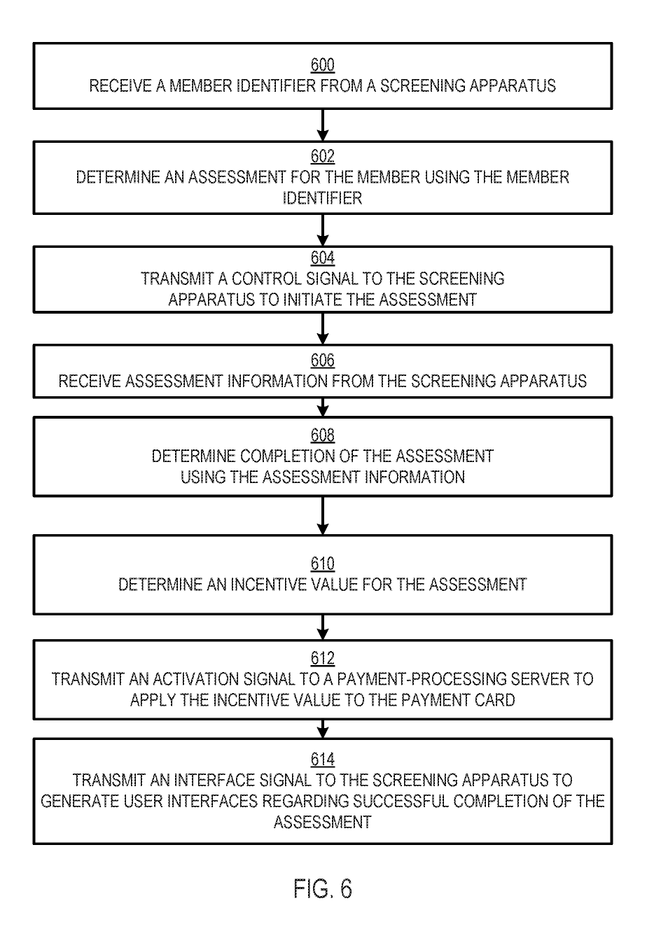

FIGS. 5-6 include flow charts illustrating processes for initiating healthcare assessments and adding incentives to payment cards for successful completion of the healthcare assessments according to aspects of the present disclosure. The processes are described with respect to FIGS. 1-4, although other implementations are possible without departing from the scope of the present disclosure. Although the steps of the processes are shown in a particular order, the steps may be performed in various orders without departing from the scope of the present disclosure. Similarly, steps in each of the processes may be omitted or performed in alternative ways without departing from the scope of the present disclosure.

FIG. 5 shows a flow chart of a process for performing an assessment according to one aspect of the present disclosure. In some aspects, the process may be implemented by the screening apparatus 104A of FIGS. 1-3, though other implementations are possible.

In block 500, member information is received. The member information may include one or more user identifiers corresponding to information that identifies the member and identifies the incentive program. In some aspects, the identifying information may be extracted from the barcode 302 of the payment card 300 by the optical scanner 202. In other aspects, the identifying information may be received as input by the user via input options on the display unit 200. For example, the identifying information may include a personal identification number, username, or password. In another example, the member may visit an available screening apparatus 104A-104N and, via the display unit 200 select, their insurance or health provider or other plan sponsor from an initial menu screen that has a series of choices of different providers. Thereafter, the member can input their member and group or plan identification information, or other identifying information.

In block 502, the member is authenticated by the screening apparatus 104A. In some aspects, the screening apparatus 104A may authenticate the member by displaying a user interface on the display unit 200 that includes an input option prompting the user to input information corresponding to the identifying information retrieved from the barcode 302. For example, the screening apparatus 104A may authenticate the member in response to the member inputting a birthdate that corresponds to a birthdate stored as identifying information on the barcode 302. In some aspects, the information on the barcode 302 may be temporarily stored in the memory 402 or other storage device of the screening apparatus 104A for comparison with the member input. In some aspects, all or a portion of this step is optional. For example, all or a portion of the authentication may be performed by the control server 102 as described herein.

In block 504, a health screening assessment is administered. In some aspects, the health screening assessment may be administered based on a selection by the member via the display unit 200 or other means of selecting a health screening assessment by the member. For example, the member may manually select a health screening assessment to be administered by the screening apparatus 104A from a list of available assessments presented on the display screen of the display unit 200. In some aspects, the list of available assessments may be stored in the memory 402 or a storage device of the screening apparatus 104A. The list of available assessments may depend on the incentive plan corresponding to the selected plan sponsor. In response to a selection of an available assessment, a selection signal corresponding to the selection may be transmitted to the control server 102 to confirm that the selected assessment is available to the member for an incentive (e.g., the member has not previously performed or received an incentive for the assessment and the assessment corresponds to an incentive plan in which the member is enrolled). The control server 102 may transmit a confirmation control signal to the screening apparatus 104A to confirm that the selected assessment is available and to prompt the screening apparatus 104A to initiate the assessment.

In other aspects, the list of available assessments may be transmitted to the screening apparatus 104A from the control server 102 via the network 106. For example, the screening apparatus 104A may transmit identifying information to the control server 102 via the network. The control server 102 may identify a list of available assessments for the member based the incentive plan associated with the member in the database 108 and transmit the list of available assessments via an electronic signal to the screening apparatus 104A. In additional and alternative aspects, the health screening assessment may be administered based on a determination by the control server 102. For example, the processor 410 of the control server 102 may identify the member based on the identifying information and may select a health care assessment for the screening apparatus 104A to administer based on health information (e.g., an incentive plan) associated with the member in the database 108. In either aspect, the control server 102 may confirm that the member has not previously performed the assessment or received an incentive for completing the assessment. The control server 102 may transmit a control signal to the screening apparatus 104A corresponding to an instruction to administer the selected assessment.

If the member fails to successfully complete the assessment, the screening apparatus may prompt the member to restart the assessment or attempt to complete the assessment within a desired time. Otherwise, the session may end without the member obtaining their desired reward.

In block 506, assessment information is received. In some aspects, the assessment information is received based the assessment being administered via a measurement device 404 of the screening apparatus 104A. For example, the assessment being administered may include a blood pressure test. The screening apparatus 104A may actuate the blood pressure measurement device 206 to determine the member's blood pressure. The measurements determined by the blood pressure measurement device 206 may correspond to the assessment information. In additional and alternative aspects, the assessment information may be received as user input. For example, the display unit 200 may be actuated to display user interfaces on the display screen having input options for the member to input information in response to questions about the member's health (e.g., “Do you have a cough or fever?”). The member's input to the questions displayed on the display screen may be received as assessment information.

In block 508, the assessment information received by the screening apparatus 104A is transmitted to the control server 102 via the network 106. The control server 102 may determine whether the assessment information is sufficient to entitle the member to the corresponding incentive. Upon determining that the assessment was successfully completed and authorizing an incentive to be added to the payment card 300, the control server 102 may transmit a control signal to the screening apparatus 104A to cause the screening apparatus 104A to display on the display unit 200 one or more user interfaces confirming that the assessment was successfully completed and that the incentive was added to the payment card 300 (block 510).

FIG. 6 shows a flow chart of a process for electronically activating a payment card according to one aspect of the present disclosure. In some aspects, the process may be implemented by control server 102 of FIGS. 1 and 3, though other implementations are possible.

In block 600, a member identifier is received from the screening apparatus 104A. The member identifier may be included in identifying information received by the control server 102 from the screening apparatus 104A via the network 106. In some aspects, the member identifier may be received by the screening apparatus 104A as described in block 500 of FIG. 5 and transmitted to the control server 102. In one example, the member identifier may correspond to an account number or other identifying information that identifies and associates the member and the member's health information associated with an incentive program stored in the database 108.

In block 602, the control device 102 determines an assessment for the member to perform. The assessment may be determined using the member identifier. For example, the member identifier may be associated with an incentive plan corresponding to the member in the database 108. The control device 102 may identify the assessment for the assessment plan and determine whether the member has previously performed the assessment or otherwise claimed an incentive associated with the assessment.

In block 604, a control signal is transmitted to the apparatus to initiate the assessment. In some aspects, the control signal may include a command that causes the screening apparatus 104A to initiate the assessment. In some aspects, initiating the assessment may include prompting the member to select the assessment. In other aspects, initiating the assessment may include generating one or more user interfaces including health questions related to the assessment or initiating a measurement device 404 to perform the assessments (e.g., taking a vision test using the vision-screening system 204.

In block 606, assessment information is received from the screening apparatus 104A. The assessment information may include data retrieved from the measurement devices 404 or the user input provided by the member as described in block 506 of FIG. 5. The screening apparatus 104A may transmit the information to the control server 102 as described in block 508 of FIG. 5.

In block 608, completion of the assessment is determined based on the assessment information. The control server 102 may determine whether the assessment information is complete by analyzing the assessment information based on program requirements. In one example, the assessment information may be stored in a designated memory location in the database 108 based on the assessment type. For example, a blood pressure assessment may correspond to a first type and the assessment information may be stored in a memory location designated for blood pressure assessment information. A weight assessment may correspond to a second type and the assessment information may be stored in a different memory location designated for weight assessment information. In some aspects, a type identifier may be included with the assessment information to allow the control server 102 to identify the type associated with the assessment. In some aspects, the control server 102 may determine that the assessment information is insufficient (e.g., incomplete) based on an inability of the assessment information to fill each of the designated memory locations in the database 108. In some aspects, this step is optional. For example, completion of assessment may be determined by screening apparatus 104A and receiving the assessment information may be indicative of such completion.

In block 610, an incentive value is determined for the assessment. In some aspects, the incentive value may be determined based on the type of assessment administered by the screening apparatus 104A. A predetermined incentive value may correspond to the assessment type and the control server 102 may identify the incentive value using the assessment type. For example, the control server 102 may determine that according to an incentive plan associated with the member in the database 108, a blood pressure assessment may yield an incentive value corresponding to a $10 monetary value and an eye vision test may yield an incentive value corresponding to a $25 monetary value. In additional and alternative aspects, the incentive value may be determined based on a level of completion of a designated incentive program for the member. For example, the incentive program may include ten assessments that the member may complete over a designated time interval (e.g., one month). The incentive value may increase depending on the number of assessments completed and the control server 102 may determine the incentive value based on the percentage of assessments completed. In some aspects, the control server 102 may analyze the assessment information (and previously stored assessment information stored in the database 108) to determine the incentive value.

In block 612, an activation signal is transmitted to the payment-processing server 112. The activation signal may include a control signal that corresponds to a request or other instruction for the payment-processing server 112 to activate the payment card 300 based on the incentive value determined in block 606. For example, the activation signal may include an instruction for the payment-processing server 112 to add a monetary value of $10 to the payment card 300 where the incentive value corresponds to $10. In some aspects, the addition of a monetary value onto the payment card 300 may transform an inactivated payment card into an activated payment card that may be used by the member to perform a transaction (e.g., initiate a $10 purchase using the payment card 300). In other aspects, the payment card 300 may have been previously activated in response to a previous assessment completed by the member, and the addition of the monetary value on to the payment card 300 may be added to a previously loaded monetary value.

In block 614, an interface signal is transmitted to the screening apparatus 104A. The interface signal may correspond to a control signal that causes the screening apparatus 104A to display a user interface or a series of user interfaces on the display unit 200. In some aspects, the user interfaces may acknowledge, confirm, or otherwise inform the member that the assessment was successfully completed and the payment card 300 is activated and usable to perform purchases. In additional aspects, the user interfaces may acknowledge that the payment card 300 includes the incentive value. The incentive value may correspond to a monetary value added to an account associated with the payment card 300.

In some aspects, additional electronic signals may be sent to additional sources via the network 106 or other means. For example, the assessment information collected from the member may be sent via electronic signals to the member's healthcare provider via the sponsor server 110, along with an indication of a successful completion of a health and wellness incentive program.

The present disclosure may allow members to utilize and obtain rewards through healthcare kiosks, making participation and achievement of plan goals and incentives easier for participants. The incentive plans and operation may be tailored by Managed Care Organizations (MCOs) as they receive the health data for each individual member as well as aggregate population health data. In some aspects, the same methodology can be used for other groups (employers, providers, health plans) for incentive and engagement purposes. In these cases, Employer Wellness Programs would only receive aggregate population data (and no individual employee data). In this manner, a variety of sponsors, including Managed Medicaid Health Plans, Medicare Advantage Health Plans, Employer Health and Wellness programs, Accountable Care Organizations, Commercial Health Plans and others, may engage members and collect data through the use of incentives. The process further encourages members to track their health and simultaneously connects their detailed health data to the patient/member record and the financial value for the payment card is activated upon completing the requirements at the kiosk, providing immediate rewards and ease of administration.

When evidence of completion of the health and wellness incentive program by the participant has been provided both to a sponsor or third-party clearing house, the health provider or health insurance company in which the participant is a member may be further provided with feedback information as to the member's health conditions based upon the member's assessment information (e.g., the member's responses and biometric inputs at the kiosk).

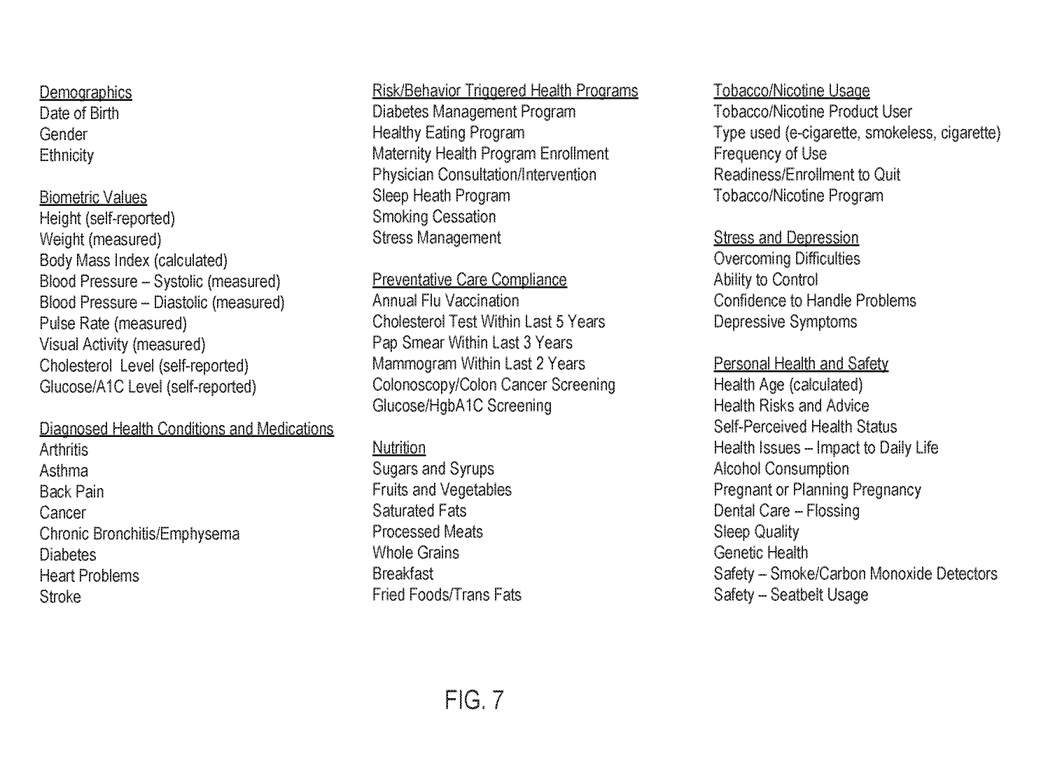

FIG. 7 illustrates example conditions or other medical information that can be provided to an incentive program sponsor, such as the member's healthcare or insurance provider. The medical information may include information measured by the measurement devices 404 of the screening apparatus 104A, information calculated or otherwise determined by the processor 410 of the control server 102 or the processor 400 of the screening apparatus 104A, and information self-reported by the member (e.g., information input by the member via the display unit 200). The sponsor (excluding Employer Wellness Programs) participating in the program may receive a complete, detailed health profile for every covered member. This information may stratify health risks and identify care gaps for each individual, giving a sponsor the ability to engage members, improve plan quality ratings and control costs. According, aspects of the present disclosure may provide an efficient, cost-effective method that minimizes the expense for population health screenings in a performance-based manner.

The foregoing description of the examples, including illustrated examples, of the invention has been presented only for the purpose of illustration and description and is not intended to be exhaustive or to limit the invention to the precise forms disclosed. Numerous modifications, adaptations, and uses thereof will be apparent to those skilled in the art without departing from the scope of this invention. The illustrative examples described above are given to introduce the reader to the general subject matter discussed here and are not intended to limit the scope of the disclosed concepts.

What is claimed is:

1. A server system, comprising:
a processing device;
a memory device communicatively coupled to the processing device and including instructions that are executable by the processing device to cause the processing device to, in response to receiving, from a medical screening apparatus communicatively coupled to the server system via a network, identifying information corresponding to a member of an incentive program:
determine an assessment for performance by the member based on the incentive program associated with stored identifying information that corresponds to the identifying information, the stored identifying information being stored in a database that is accessible to the processing device;
transmit a first control signal to the medical screening apparatus to cause the medical screening apparatus to prompt the member to initiate the assessment;
receive assessment information from the medical screening apparatus, the assessment information corresponding to information generated by the medical screening apparatus in response to the member performing the assessment;
determine an incentive value associated with completion of the assessment;
transmit a second control signal to a payment-processing server communicatively coupled to the server system via the network to cause the payment-processing server to apply the incentive value to a payment card associated with the member; and
transmit a third control signal to the medical screening apparatus to cause the medical screening apparatus to generate one or more user interfaces that are displayable on a display screen of the medical screening apparatus and include a message informing the member that the incentive value is associated with the payment card.

2. The server system of claim 1, wherein the database comprises:
a plurality of stored user identifiers corresponding to a plurality of members of the incentive program; and
for each member of the plurality of members, stored authentication information and stored incentive program information, the stored authentication information and the stored incentive program information being associated with a respective user identifier of the plurality of stored user identifiers in the database,
wherein the stored authentication information is usable to authenticate each member of the plurality of members to conduct the assessment using the medical screening apparatus,
wherein the stored incentive program information includes information received from a sponsor server communicatively coupled to the server system and associated with a sponsor of the incentive program.

3. The server system of claim 1, wherein the instructions are further executable by the processing device to cause the processing device to authenticate the member to perform the assessment using the medical screening apparatus based on the identifying information and the stored identifying information.

4. The server system of claim 3, wherein the instructions are executable by the processing device to cause the processing device to authenticate the member to perform the assessment by:
receiving, from the medical screening apparatus, the identifying information, the identifying information including at least a user identifier corresponding with the member and extracted by an optical scanner of the medical screening apparatus from the payment card;
identifying a stored user identifier stored in the database that corresponds to the user identifier, the stored user identifier being included in the stored identifying information;
determining a correspondence between the user identifier and the stored user identifier.

5. The server system of claim 1, wherein the instructions are executable by the processing device to cause the processing device to determine the incentive value by
identifying a type associated with the assessment; and
identifying the incentive value corresponding to the type based on the incentive program associated with the member in the database.

6. The server system of claim 1, wherein the incentive value corresponds to a monetary value to be loaded onto the payment card.

7. The server system of claim 1, wherein determining the assessment includes:
identifying a plurality of assessments corresponding to the incentive program that is associated with the identifying information in the database; and
identifying an available assessment of the plurality of assessments, the available assessment corresponding to an unperformed assessment that the member has not previously performed or an eligible assessment that is eligible for the incentive value.

8. The server system of claim 1, wherein the payment card includes one of: (i) a physical card having a barcode that is readable by an optical scanner of the medical screening apparatus to extract a user identifier corresponding to a stored user identifier stored in the database; or (ii) a virtual card represented by a user code corresponding to the stored user identifier or a digital barcode including the user identifier.

9. The server system of claim 1, wherein the medical screening apparatus comprises a health kiosk including:
the display screen configured to display a series of user interfaces generated in response to the first control signal to guide the member through the assessment; and
an assessment measurement device configured to (i) measure an assessment parameter of the member during the assessment and (ii) generate the assessment information corresponding to a measurement of the assessment parameter.

10. The server system of claim 1, wherein the medical screening apparatus comprises a mobile computing device running a mobile application that is configured to display a series of user interfaces generated in response to the first control signal to guide the member through the assessment, and wherein at least one user interface of the series of user interfaces includes an input option to allow the member to input assessment information corresponding to the health assessment.

11. A computer-implemented method, comprising:
determining, by a processor, an assessment for performance by a member of an incentive program based on the incentive program associated with identifying information received from a medical screening apparatus communicatively coupled to the m in a database accessible to the processing device;
transmitting a first control signal to the medical screening apparatus to cause the medical screening apparatus to prompt the member to initiate the assessment;
receiving assessment information from the medical screening apparatus, the assessment information corresponding to information generated by the medical screening apparatus in response to the member performing the assessment;
determining an incentive value associated with completion of the assessment;
transmitting a second control signal to a payment-processing server communicatively coupled to the server system via the network to cause the payment-processing server to apply the incentive value to a payment card associated with the member; and
transmitting a third control signal to the medical screening apparatus to cause the medical screening apparatus to generate one or more user interfaces that are displayable on a display screen of the medical screening apparatus and include a message informing the member that the incentive value is associated with the payment card.

12. The computer-implemented method of claim 11, further comprising:
authenticating, by the processor, the member to perform the assessment using the medical screening apparatus by determining a correspondence between at least a portion of the identifying information and at least a portion of the stored identifying information.

13. The computer-implemented method of claim 11, wherein transmitting the first control signal to the medical screening apparatus includes causing the medical screening apparatus to actuate a measurement device to extract a biometric measurement from the member,
wherein receiving the assessment information includes receiving the biometric measurement.

14. The computer-implemented method of claim 11, wherein determining the incentive value includes:
identifying a type associated with the assessment; and
identifying the incentive value corresponding to the type based on the incentive program associated with the member in the database.

15. The computer-implemented method of claim 11, wherein determining the incentive value includes:
receiving the assessment information;
retrieving stored assessment information corresponding to the member from a database, the stored assessment information including a count of successfully completed assessments; and
determining, based on the count of successfully completed assessments.

16. The computer-implemented method of claim 11, further comprising transmitting an electronic signal to a third-party server hosted by a sponsor of the incentive program a health profile corresponding to the member, the health profile including stored assessment information stored in the database and corresponding to one or more healthcare assessments completed by the member, the stored assessment information including a combination of (i) self-reported information provided by the member via the medical screening apparatus or a second medical screening apparatus communicatively coupled to the processor, and (ii) measured information received using a measurement device of the medical screening apparatus or the second medical screening apparatus.

17. A computer-implemented method for administering a healthcare assessment, comprising:
receiving, by a processor of a medical screening apparatus, identifying information corresponding to a member of a healthcare incentive program;
authenticating, by the processor, the member to perform a healthcare assessment using the medical screening apparatus;
administering, by the processor, the healthcare assessment to the member in response to a first control signal received from a remote server communicatively coupled to the medical screening apparatus via a network;
receiving, by the processor, assessment information corresponding to the healthcare assessment;
transmitting, by the processor, the assessment information to the remote server;
receiving, by the processor, a second control signal from the remote server; and
generating, by the processor and in response to receiving the second control signal, one or more user interfaces indicating to the member that an incentive value corresponding to successful completion of the healthcare assessment is applied to a payment card associated with to the member and the healthcare incentive program.

18. The computer-implemented method of claim 17, wherein receiving the identifying information includes extracting, by an optical scanner of the medical screening apparatus, the identifying information from a barcode positioned on the payment card.

19. The computer-implemented method of claim 17, wherein authenticating the member comprises:
displaying, by a display unit of the medical screening apparatus, an input user interface including an input option for the member to input inputted identifying information;
receiving the inputted identifying information; and
determining, by the processor, a correspondence between the inputted identifying information and at least a portion of the identifying information.

20. The computer-implemented method of claim 17,
wherein receiving the identifying information includes initiating a health screening session, the health screening session corresponding to a single visit by the member to the medical screening apparatus and including at least said authenticating the member, said administering the healthcare assessment, said receiving the assessment information, and said generating the one or more user interfaces indicating to the member that the payment card is activated.
